(19) United States
(12) Patent Application Publication
(10) Pub. No.: US 2005/0281920 A1
(43) Pub. Date: Dec. 22, 2005

(54) Comestible product dispensers and methods of making and using same

(76) Inventors: William J. Maskell, London (GB); David Salmon, Hertfordshire (GB)

Correspondence Address: Bell, Boyd & Lloyd LLC, P.O. Box 1135, Chicago, IL, 60690-1135, US

(21) Appl. No.: 11/157,424

(22) Filed: Jun. 21, 2005

Related U.S. Application Data
(60) Provisional application No. 60/582,384, filed on Jun. 22, 2004.

(51) Int. Cl. A23L 1/216

(52) U.S. Cl. 426/106

(57) ABSTRACT

A first product dispenser is provided and includes a first housing sized to hold a plurality of comestible products, a second housing sized to hold a plurality of the comestible products and a member holding the first and second housings together so that the first and second housings can each be translated sequentially along the divider to dispense one of the products. A second product dispenser is provided and includes a housing sized to hold a plurality of the comestible products, the housing including a top and a base separated by a plurality of product dividers, and a belt held by the housing so that an opening in the belt is manually and selectively able to be rotated into registry between the dividers to dispense one of the products.

### BACKGROUND

The present disclosure relates generally to packaging. More particularly, the present disclosure relates to packaging or dispensers for storing and dispensing comestible products.

The packaging for comestible products is very important to the look, marketing and storage of the product. Very often, in addition to text on the packaging, the packaging also attempts to visually convey a message about the type of product, the taste of the product or the purpose of the product. For example, packages for cinnamon or cherry tasting products are often red, grape tasting product packaging is often purple, etc. Once the consumer has identified a desired brand, the consumer can typically choose a product based solely on the color of the packaging.

In marketing the product, packaging can convey other information besides taste whereby the consumer can thereby associate the product with its effect by simply viewing the packaging.

There are also practical facets to packaging comestible products, namely, keeping the products from being damaged during shipping, keeping the products fresh, and in certain instances providing a reusable package. Some comestible products do not require that the packaging be robust, sturdy or reusable.

Other comestible products are packaged in pieces and may or may not be provided in a reusable package, as desired by the manufacturer. If it is felt that only a portion of the products may be consumed in one sitting, the manufacturer may wish to provide a box having a hingedly connected lid or other type of re-sealable cover.

With certain comestible products, the consumer tears open a package and removes a product or piece of the product. One problem with this type of packaging is that the remaining product tends to fall out of the package after the consumer removes one or more pieces from the package. Another problem with these packages is that it becomes difficult, especially with a newly opened package, to remove a piece without ripping open a significant portion of the package.

Attempting to provide a package that holds the product even after the removal of one or more pieces of the product can make removing the comestible product more difficult. Tightly packing the product may aid in holding the product at the expense of gaining access to the product.

It is therefore desirable to provide a comestible product dispenser that enables a user to be able to remove a desired number of pieces of comestible product from the dispenser.

It is also desirable to provide a comestible product dispenser that maintains the products even after a number of the products have been removed from the dispenser.

Furthermore, it is desirable to provide comestible products in a dispenser, wherein the products are readily accessible and removable.

It is also desirable to provide a comestible product dispenser that is re-usable.

Furthermore, it is desirable to provide a comestible product dispenser that holds, separates and dispenses individually unwrapped products.

### SUMMARY

The present disclosure provides multiple apparatuses and methods for dispensing products, such as products that are individually unpackaged. The products in one embodiment are comestible products. The teachings of the present disclosure, however, are not dependent upon the products being any particular type as long as the products can fit within the product dispensers described herein. The dispensers herein, regardless of what product is being dispensed, are configured to be highly functional, to have an aesthetic element, and to provide a suitable tactile feel for the user and consumer.

It is believed that users of comestible products find certain features desirable and undesirable in the packaging of products consumed on a daily basis. Specifically, it is believed that consumers desire a compact shape for easy, everyday storage. It is an added benefit to the manufacturer if the shape is also innovative and/or sleek looking. Such a shape gains customer attention. Furthermore, it is desirable to have a dispenser that is intuitive and easy to determine how to use. Still further, consumers desire the dispenser to be quiet and to not require too much manipulation, so that the products can be dispensed in an easy and discrete manner.

Moreover, control over product dispensing is important. That is, consumers want to be able dispense only a desired amount of product. To that end, especially in the case of individually unpackaged products, it is desirable that the products do not stick or clump together. One-handed operation is also desirable.

The present disclosure provides in an embodiment, a comestible product dispenser including a first housing sized to hold a plurality of comestible products and a second housing sized to hold a plurality of the comestible products. The product dispenser also includes a member adapted to hold the first and second housings together, where the member including a first side coupled in a sliding relationship with the first housing and a second side coupled in a sliding relationship with the second housing. A first stop is connected to the first side of the member and a second stop connected to the second side of the member, where the first and second stops are constructed and arranged to prevent or limit the movement of the first and second housings past either of the ends of the member when the first and second housings are translated sequentially along the divider to dispense one of the products. The stops therefore temporarily secure the housings in an open or closed position for dispensing product from the product dispenser or for maintaining the product in the product dispenser.

In an embodiment, the first housing and the second housing are constrained initially by a tamper resistant tab. In another embodiment, the first housing and the second housing are constrained initially by a plurality of tamper resistant tabs. The tabs are broken or removed by moving one or both of the housings past an end of the member.

Another embodiment of the product dispenser of the present invention includes a housing sized to hold a plurality of the comestible products. The housing includes a top wall and a bottom wall separated by a plurality of product dividers. The product dispenser also includes a dispensing member such as a belt held by the housing and extending between the top wall and the bottom wall. The dispensing member defining at least one opening and is movable along the dividers. A holding member is connected to the housing and is adapted to enable a user to sufficiently hold the housing so that the dispensing member can be manually and selectively moved to position the opening between the dividers to dispense one of the products.

In an embodiment, the holding member includes a contoured surface.

In an embodiment, the opening is covered initially by a tamper resistant tab.

In an embodiment of a method for dispensing comestible product, the method provides the steps of configuring a first housing to hold a plurality of comestible products and configuring a second housing to hold a plurality of the comestible products. The next step includes engaging the first housing and the second housing in a sliding arrangement with a member having a first stop and a second stop. The following steps includes enabling a person to slide the first housing along the member until the first housing engages the first stop to prevent further movement of the first housing past an end of the member and dispense at least one product from the first housing and enabling a person to slide the second housing along the member until the second housing engages the second stop to prevent further movement of the second housing past an end of the member and dispense at least one product from the second housing.

In an embodiment, the method further includes the step of providing the first housing with a first tab and the second housing with a second tab, where the first and second tabs are constructed and arranged to engage the first and second stops to limit the movement of the first and second housings along the member.

In another embodiment of a method of operating the product dispenser, the method includes the steps of configuring a housing to include a holding member so that a user can hold the housing, configuring a belt to be held by and rotatable around at least one opening defined by the housing, where the belt defines an opening; and manually moving the belt around the housing to align the openings and selectively enable products to be dispensed through the aligned openings of the housing and the belt.

In an embodiment, the method includes providing tactile devices so that the opening of the belt can be set at a desired position until being moved again.

It is therefore an advantage of the present disclosure to provide a product dispenser for dispensing individually unwrapped products, where the products do not stick to one another or clump.

It is another advantage of the present disclosure to provide dispensers that are compact and easily stored.

It is a further advantage of the present disclosure to provide innovative dispensers that are enjoyable to operate and that are attractive to consumers.

It is a further advantage of the present disclosure to provide product dispensers that are intuitive to use.

Moreover, it is an advantage of the present disclosure to provide product dispensers that are controllable to dispense only a desired amount of product.

Yet further, it is an advantage of the present disclosure to provide product dispensers that dispense products via gravity alone without agitation.

Furthermore, it is an advantage of the present disclosure to provide product dispensers that can be maneuvered and manipulated with one hand.

Additional features and advantages of the present disclosure are described in, and will be apparent from, the following Detailed Description and the Figures.

### BRIEF DESCRIPTION OF THE FIGURES

FIG. 1 illustrates a top perspective and assembled view of one embodiment of the product dispenser of the present disclosure.

FIG. 2 illustrates a bottom perspective and exploded view of the product dispenser of FIG. 1.

FIG. 3 illustrates a top perspective view of the dispenser of FIG. 1, which has been partially maneuvered to break a tamper proof tab.

FIG. 4 illustrates a top perspective view of the dispenser of FIG. 1, showing the method of operation and assembly of the dispenser, which is dispensing one of the products.

FIG. 5 illustrates a top perspective and assembled view of a second embodiment of the product dispenser of the present invention, which has a rotating belt located at a parked or non-dispensing position.

FIG. 6 illustrates the top perspective view of the dispenser shown in FIG. 5, wherein the rotatable belt of the dispenser has been moved in registry with a product that has been dispensed from the dispenser.

FIG. 7 is a front perspective and exploded view of the dispenser of FIG. 5, showing the separated dispenser lid, base and rotating belt.

FIG. 8 illustrates a top perspective exploded view of another embodiment of the product dispenser of the present disclosure.

FIG. 9 illustrates a top view of the member of the product dispenser of FIG. 8.

FIG. 10 illustrates an end view of the member of FIG. 9.

FIG. 11 illustrates a side view of the member of FIG. 9.

FIG. 12 illustrates a top view of one of the housings of the product dispenser of FIG. 8.

FIG. 13 illustrates a left side view of the housing of FIG. 12.

FIG. 14 illustrates a right side view of the housing of FIG. 12.

FIG. 15 illustrates an end view of the housing of FIG. 12.

FIG. 16 illustrates a cross section view taken substantially along line XVI-XVI shown in FIG. 15.

FIG. 17 illustrates a cross section view taken substantially along line XVII-XVII shown in FIG. 12.

FIG. 18 illustrates a method of operating the product dispenser of FIG. 8 where a user moves one of the housings of the product dispenser to an open position to dispense comestible product from the housing.

FIG. 19 illustrates a method of operating the product dispenser of FIG. 8 where the user moves the housing of the product dispenser to a closed position to prevent further product from being dispensed from the housing.

FIG. 20 illustrates a top view of another embodiment of the product dispenser of the present disclosure.

FIG. 21 illustrates a cross section view taken substantially along the line XXI-XXI shown in FIG. 20.

FIG. 22 illustrates a right side view of the housing shown in FIG. 20.

FIG. 23 illustrates an end view of the housing of FIG. 20.

FIG. 24 illustrates a top view of the other housing of the product dispenser of FIG. 20.

FIG. 25 illustrates a cross section view taken substantially along the line XXV-XXV shown in FIG. 24.

FIG. 26 illustrates a right side view of the housing of FIG. 24.

FIG. 27 illustrates an end view of the housing of FIG. 24.

FIG. 28 illustrates an embodiment of a belt held by the housings of FIGS. 20 and 24.

FIG. 29 illustrates a top view of the belt of FIG. 28.

FIG. 30 illustrates a cross section view of the belt taken substantially along the line XXX-XXX shown in FIG. 28.

### DETAILED DESCRIPTION

The present disclosure provides multiple apparatuses and methods for dispensing comestible products. The dispensers are well suited for dispensing individual products that are unwrapped. The present invention is expressly not limited, however, to dispensers and methods for dispensing individually unwrapped edible products. The dispensers and methods work equally as well with edible products that are individually wrapped. Moreover, the products can be used to dispense drugs, for example, in tablet form. Furthermore, the dispenser can be used to dispense non-edible products, such as small household items or coins. It should be appreciated that any suitable products may be dispensed form the product dispensers of the present invention.

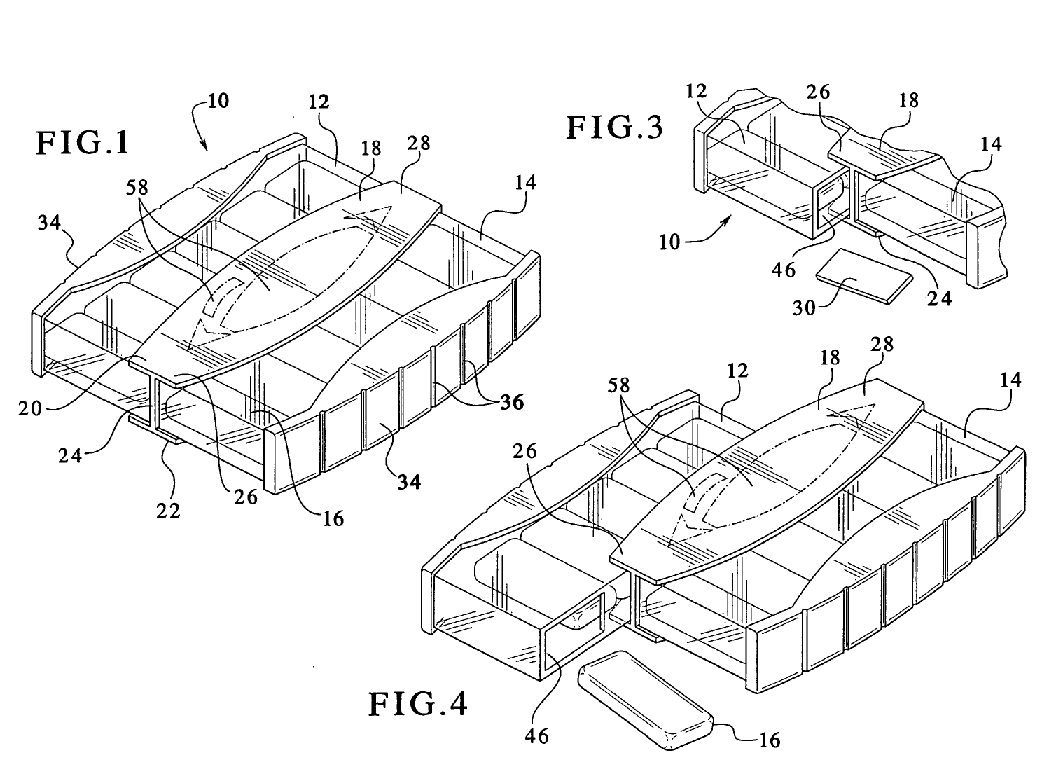

Referring now to the drawings and in particular to FIGS. 1 to 4, an embodiment of a dispenser of the present invention is illustrated by dispenser 10. Dispenser 10 includes a first housing 12 and a second housing 14. Housings 12 and 14 are made of any suitable type of plastic, paper, cardboard, rubber, metal, ceramic or composite material. In one embodiment, housings 12 and 14 are smooth, transparent or translucent plastic housings. Being at least translucent enables a consumer to see how many individual products 16 remain within dispenser 10. Housings 12 and 14 can be tinted or colored and still enable the consumer to view products 16 contained within. In an alternative embodiment, housings 12 and 14 are opaque. Additionally, the material of housings 12 and 14 can be coated or treated to be resistant to ultraviolet light, for example, to help prevent products 16 from being heated, becoming tacky or melting. The insides of housings 12 and 14 can also be coated to help dispense products 16 readily and via gravity alone.

Housings 12 and 14 are held together by a member 18. Member 18 includes a top 20 and a bottom 22, which are separated by a divider 24. Member 18 also has a first end 26 and a second end 28. Member 18 is made of any of the materials listed above and in various preferred embodiments is paper, foil, cardboard or any combination thereof. Member 18 includes branding or design indicia 58, which can be printed directly thereon or be provided on a separate label that is adhered to member 18.

As seen in FIG. 3, the first end 26 of member 18 includes a tamper resistant tab 30 that breaks or tears away when dispenser 10 is used initially. Tab 30 can be made of any suitable material, such as paper, cardboard or foil. Tab 30 can be made of the same or of a different material as member 18. For example, top 20, bottom 22 and divider 24 can be constructed of a first material, such as cardboard or plastic, while tab 30 is constructed of a second material, such as paper or foil.

Tab 30 is connected to member 18 such that tab 30 breaks free when the user slides either housing 12 or housing 14, without requiring an excessive amount of force from the user. On the other hand, tab 30 is chemically or mechanically connected to member 18 sufficiently so that tab 30 does not break or rupture inadvertently via shipping or before the user has an opportunity to dispense one of the products 16 from dispenser 10. Tab 30 can be sealed to bridge 24 and member 18 so that only one side of tab 30 opens when either housing 12 or 14 is moved initially. Alternatively, separate tamper resistant tabs 30 are provided, one for each housing. In any event, dispenser 10 can be made so that only one tamper proof tab is broken as long as only one housing 12 or 14 is moved.

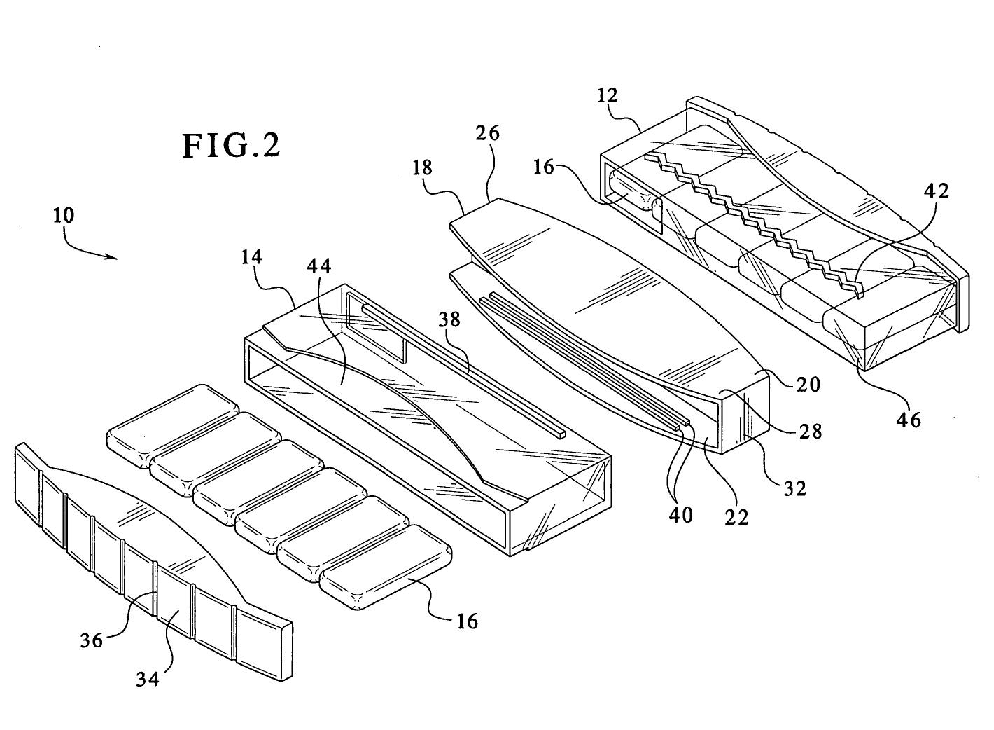

FIG. 2 illustrates that end 28 of member 18 includes a wall or stop 32. FIGS. 3 and 4 illustrate that either one of housings 12 or 14 can be pushed in from end 28 of member 18 and out past end 26 of member 18. Stop 32 prevents either of housings 12 or 14 from being pushed past end 28 of member 18. Stop 32 also provides a fixed surface against which the user can move either housing 12 or 14 against the other of housing 12 or 14. That is, if stop 32 were not present and the user attempted to slide housing 12 against housing 14, both housings would slide in opposite directions, preventing the user from achieving the desired movement of one of the housings to open and dispense a product 16 from within.

Grips 34 are provided along the outer edges of housings 12 and 14 to aid the consumer in grasping and sliding the housings. In one embodiment, grips 34 are made of rubber or other type of material that is relatively soft and frictionally suitable to be grasped and pushed. Alternatively, grips 34 could be made of plastic, metal, paper, cardboard, foil or other material. While housings 12 and 14 are translucent or transparent in one embodiment, grips 34 can be opaque if desired. Grips 34 also include ribs 36 or other types of knurls or projections that also aid the user in grasping and moving housings 12 and 14 with respect to member 18 and with respect to each other.

FIG. 2 illustrates one possible method of coupling housings 12 and 14 in a slideable type of engagement with member 18. Housing 14 is shown having a raised lip 38 that fits within a track 40 extending downwardly from top 20 (not seen) on both sides of divider 24 of member 18. Second tracks 40 are also provided and extend upward from bottom 22 on both sides of divider 24 of member 18. Those second tracks 40 engage second lips 38 extending from and along the bottom of housings 12 and 14. In an alternative embodiment, if either housings 12, 14 or member 18 is sufficiently thick, the thick piece can define a groove that couples with a lip of the other piece to provide the desired sliding engagement. Two or more adjacent lips 38 can alternatively be provided to fit with one or more adjacent track 40 as needed to provide a stable sliding motion between member 18 and housings 12 and 14. Lips 38 and tracks 40 can also be flip-flopped so that housings 12 and 14 define or include the tracks, while member 18 defines or includes the lips 38.

An alternative serrated lip 42 is illustrated on housing 12. Serrated lip 42 couples with one or more mating serrated lip or track extending down from the top 20 (not illustrated) of member 18. The serrated lip 42 serves two purposes. First, it helps the housings 12 and 14 to remain in a closed position with respect to member 18 when dispenser 10 is not being used or in an open position to dispense a product 16. That is, the serrations prevent housings 12 and 14 from inadvertently sliding open or closed after tab 30 has been removed, thereby preventing products 16 from being dispensed inadvertently and preventing the housings from closing before a product has been dispensed.

The serrated lip 42, when being slid along a mating lip of member 18, also provides a tactile sensation to the user. It should be appreciated that the tactile sensation can be created via any suitable type of projections, bumps, indentations and other non-uniformities. Such tactile sensation may aid the operation of dispenser 10, for example, by enabling the user to feel and/or hear an amount of movement as opposed to being forced to visually determine how far the housing has been slid. One goal of the dispenser 10 of the present invention is to provide a dispenser that is intuitive and easily maneuvered, preferably with one hand.

In one preferred embodiment, housings 12 and 14 are identical structures. FIG. 2 shows that the outer edges of the housings include indentations 44 that are contoured to receive grips 34. Grips 34 can be adhered to housings 12 or 14 and/or snap or pressure fit in place. Alternatively, grips 34 and housings 12 and 14 can be heat sealed, sonically sealed, sealed via radio frequency welding or connected via any other suitable means. As seen in FIGS. 2, 3 and 4, an inner side 46 of housings 12 and 14 is open so that a product 16 can be dispensed though the open side 46 when the respective housing is slid past end 26 of member 18.

Although not illustrated, housings 12 and 14 can include separators that are placed between products 16 to partially or completely isolate the products from one another. Alternatively, the clearance between the housings 12 and 14 and the thickness of the products 16 is sized such that it is difficult or impossible for one of the products 16 to become unaligned within the housings. To that end, the products 16 can also be tightly laterally packed within the housings. As illustrated, products 16 can also be tapered at their edges to minimize the amount of contact area between adjacent or abutting products 16.

The products 16 or the inner surfaces of housings 12 and 14 can be coated, made smooth or otherwise adapted to reduce the amount of friction between products 16 and such inner surfaces. In one preferred embodiment, the interface between products 16 and housings 12 and 14 is such that the products are readily dispensed due only to the force of gravity and do not require the user to shake dispenser 10 and potentially create noise. Also, dispenser 10 enables a single product, or multiple products if desired, to be dispensed readily without sticking or clumping.

It is believed that dispenser 10 provides a desirable apparatus especially for younger consumers for many reasons. One reason is that dispenser 10 has a certain amount of “play” value, wherein the package 10 is fun to maneuver and manipulate. The tactile feedback of the relative sliding motion also enhances such play value. To that end, the user can dispense products alternatingly from housings 12 and 14, dispense all products from one housing before dispensing any products from the other or dispense products in any desired combination or sequence.

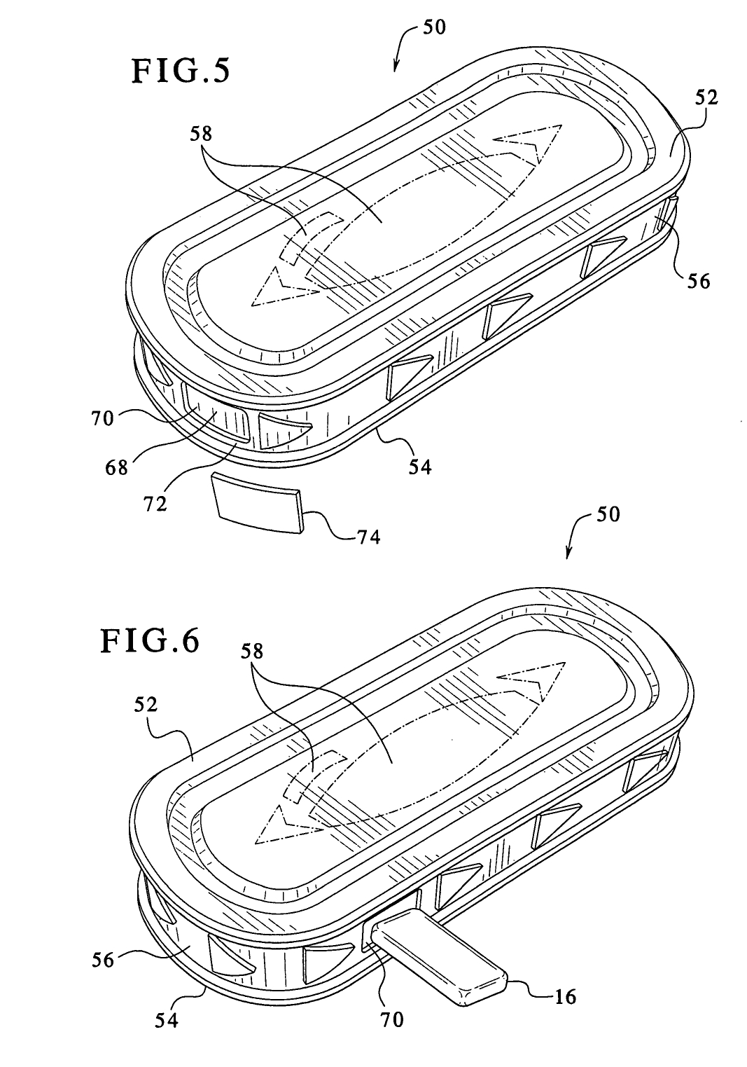

Referring now to FIGS. 5 to 7, another embodiment for dispensing products 16 is illustrated by dispenser 50. Products 16 can be any of the products described above for use in connection with dispenser 10, such as any type of comestible product, a medicament, a combination thereof, a tablet or even a non-edible type of product. Dispenser 50 includes a lid 52 and a base 54, which are made of any of the materials described above for housings 12 and 14. In one preferred embodiment, lid 52 and base 54 are translucent or transparent, so that a user can look into package 50 to determine how many products 16 remain.

Dispenser 50 differs from dispenser 10 in that the product and branding information 58 is printed or otherwise marked on the plastic or other type of housing material of lid 52 and/or base 54. Such branding or markings 58 are provided alternatively on lid 52 and/or base 54 via a separate label adhered to the lid and/or base. In any event, dispensers 10 and 50 both provide ample space for marking any suitable design, trademark, trade name, etc. Such markings 58 can also include functional markings, such as arrows pointing in the translational direction of travel in connection with dispenser 10 and a preferred rotational direction of travel of a belt 56 with respect to dispenser 50.

Belt 56 alternatively or additionally can include directional markings 60, indicating a preferred direction of rotational motion for the belt. Markings 60 in one embodiment are projections that double as gripping apparatuses, which help to increase friction and tactile feel provided by belt 56 to the user. Belt 56 in one embodiment is rubber, plastic, paper or any of the materials described above in connection with dispenser 10. In a further alternative embodiment, there is no preferred direction of rotation and belt 56 can be freely rotated in a clockwise or counterclockwise manner. In such a case, projections 60 can have an alternative shape, such as the shape of ribs 36, which does not indicate any preferred direction of rotation.

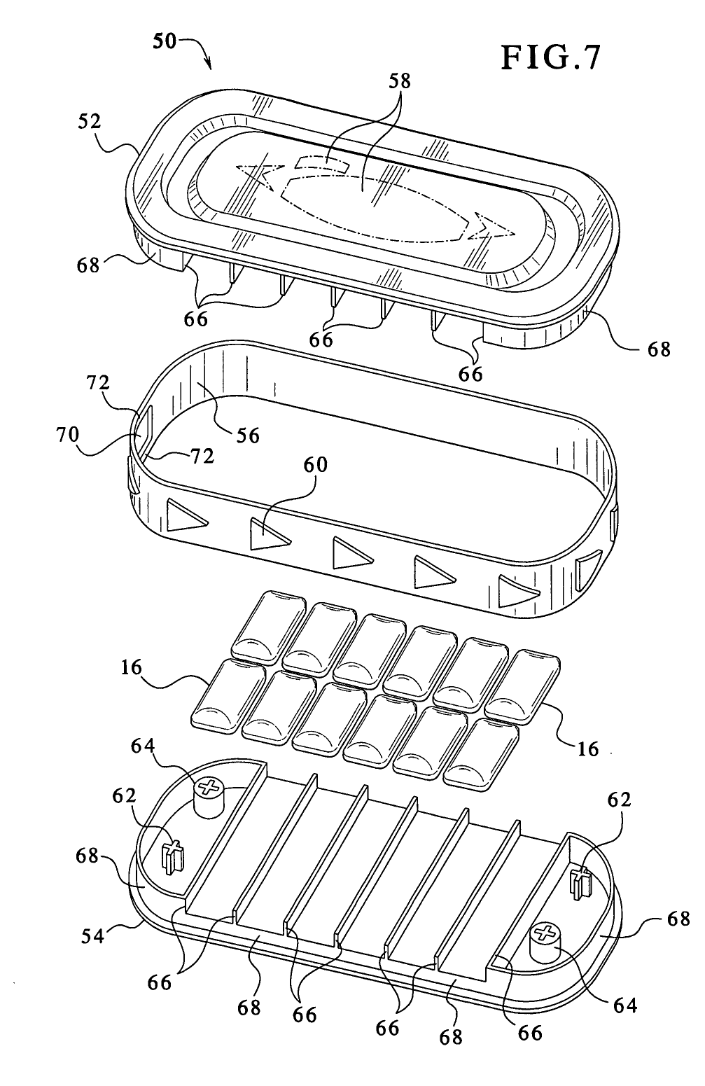

Lid 52 and base 54, like housings 12 and 14, in one preferred embodiment, are identical components, which can includes like or different indicia 58. As seen in FIG. 7, lid 52 and base 54 are both provided with alternating male mounting structures 62 and female mounting structures 64, which enable lid 52 and base 54 to press-fit or snap-fit together. Other suitable apparatuses can also be provided to couple lid 52 and base 54 together mechanically. Alternatively or additionally, a suitable adhesive or weld can be employed to attach lid 52 to base 54.

In the illustrated embodiment, lid 52 and base 54 each include a plurality of mating divider projections 66. Projections 66 of lid 52 meet projections 66 of base 54 to create a divider that separates products 16 from one another. Such dividers 66 are alternatively provided with dispenser 10 as discussed above. Further alternatively, dividers 66 are not provided and products 16 are instead packaged abutting one another as illustrated in connection with dispenser 10.

FIG. 7 illustrates that a plurality of rows of products 16 are stored between lid 52 and base 54. Although not seen, additional dividing projections, such as divider halves 66, can be provided on lid 52 and base 54 to separate and isolate the different rows of products 16 stored within the chamber defined between lid 52 and base 54.

Lid 52 and base 54 also define or provide guides halves 68. End portions of guides 68 are semi-circular, ovular, elliptical or otherwise suitable to engage belt 56. Guides 68 as illustrated extend at different heights all the way around the perimeters of lid 52 and base 54. In an alternative embodiment, guides 68 extend only part way around the perimeters of one or both lid 52 and base 54. As illustrated, guides 68 mate at the end portions of lid 52 and base 54 when the lid is mated with base 54 to provide a continuous and supporting surface around which belt 56 is rotated. The height of guide 68 along the dispensing sides of dispenser 50 is not as high as at the ends (to allow products 16 to be dispensed from the chamber between lid 52 and base 54) but is at least as high or higher than the edges 72 of belt 56 defining an opening 70. That feature ensures that the products 16 do not catch belt 56 as they are being dispensed from dispenser 50.

Guides 68 and belt 56 are smooth and possibly lubricated in one embodiment, alternatively, guides 68 include perforations, ribs or other types of projections or serrations that in combination with similar ribs, projections, perforations or serrations on snugly fitting belt 56 cause a tactile feel of belt 56 around guide 68 to be non-smooth and perhaps provide a slight clicking noise. Such tactile feedback and noise aids the consumer in maneuvering the belt 56 to a desired position. Such perforations, serrations, projections and other non-uniformities also help to hold belt 56 in place with respect to guide 68 when dispenser 50 is being stored or after belt 56 has been rotated to a desired location.

FIGS. 5 to 7 each illustrate that belt 56 defines opening or aperture 70. FIG. 5 illustrates aperture 70 positioned around the end of guide 68 in a parked or non-dispensing position. Once a tamper proof tab 74 is removed from the belt 56, sealed initially to sides 72 defining aperture 70, and the aperture is moved in front of a product 16, the product can be dispensed. Tab 74 can be made of any of the materials discussed above for tab 30 and be removably coupled to belt 56 according to any of the methods described above for tab 30.

FIG. 6 illustrates that aperture 70 has been rotated to be in registry with a portion of an open chamber defined between lid 52 and base 54 and between divider portions 66. In such position, aperture 70 enables one of the products 16 to be dispensed from dispenser 50. Afterwards, the user can rotate belt 56 in the same direction to another product opening or to a parked position at either end of dispenser 50. Alternatively, the user can rotate belt 56 in an opposite direction towards another product opening or to a parked position at one of the ends of dispenser 50.

Dispenser 50, like dispenser 10 also, has a certain amount of “play” value that is desirable especially for younger consumers. The rotating belt dispenser 50 is intuitive, and like the sliding dispenser 10, readily enables products 16 to be dispensed with one hand from the dispenser. As before, dispenser 50 enables products 16 to be dispensed via gravity alone and does not require shaking or jostling by the user.

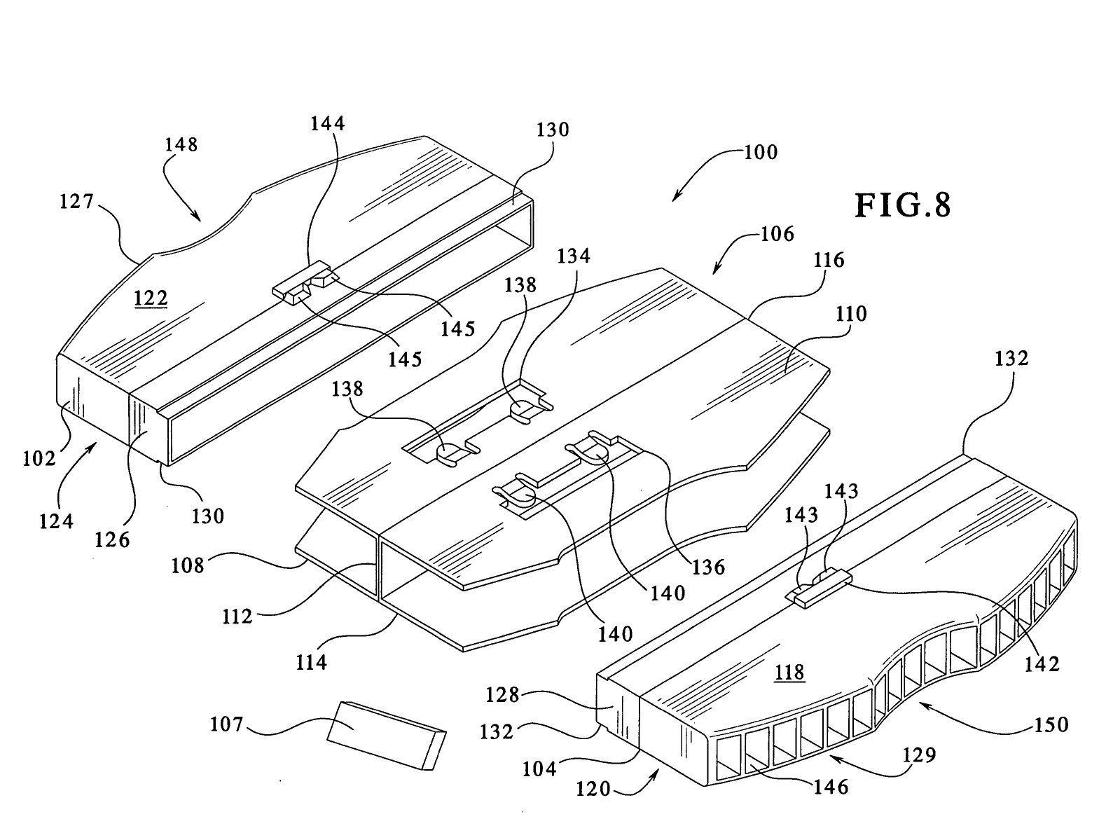

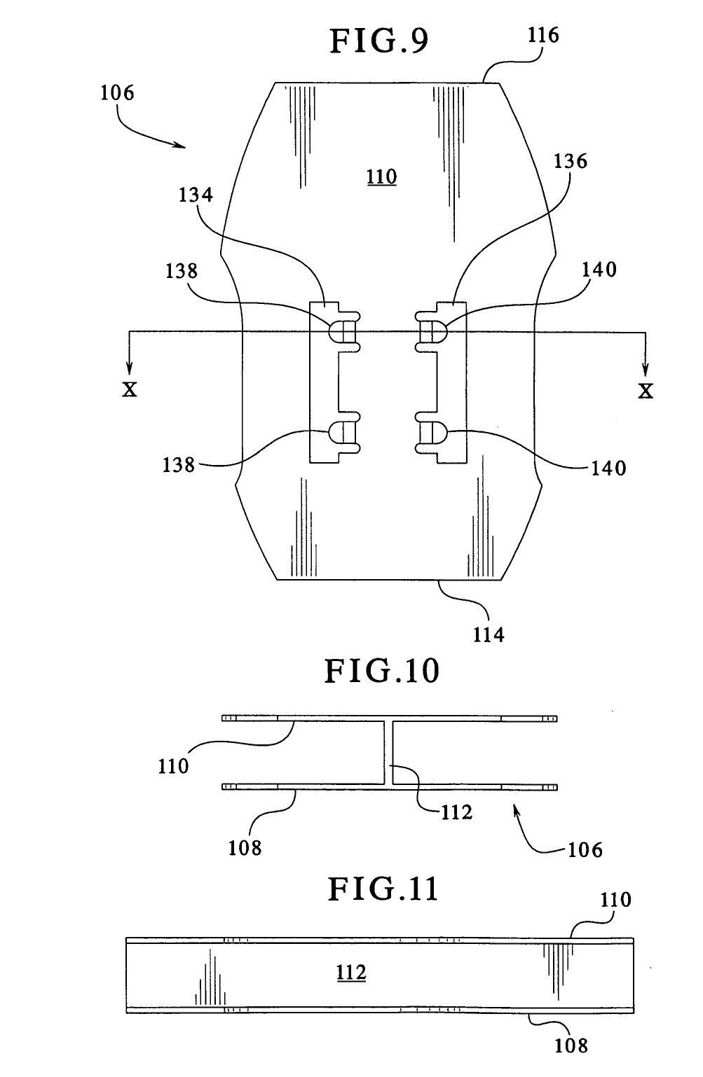

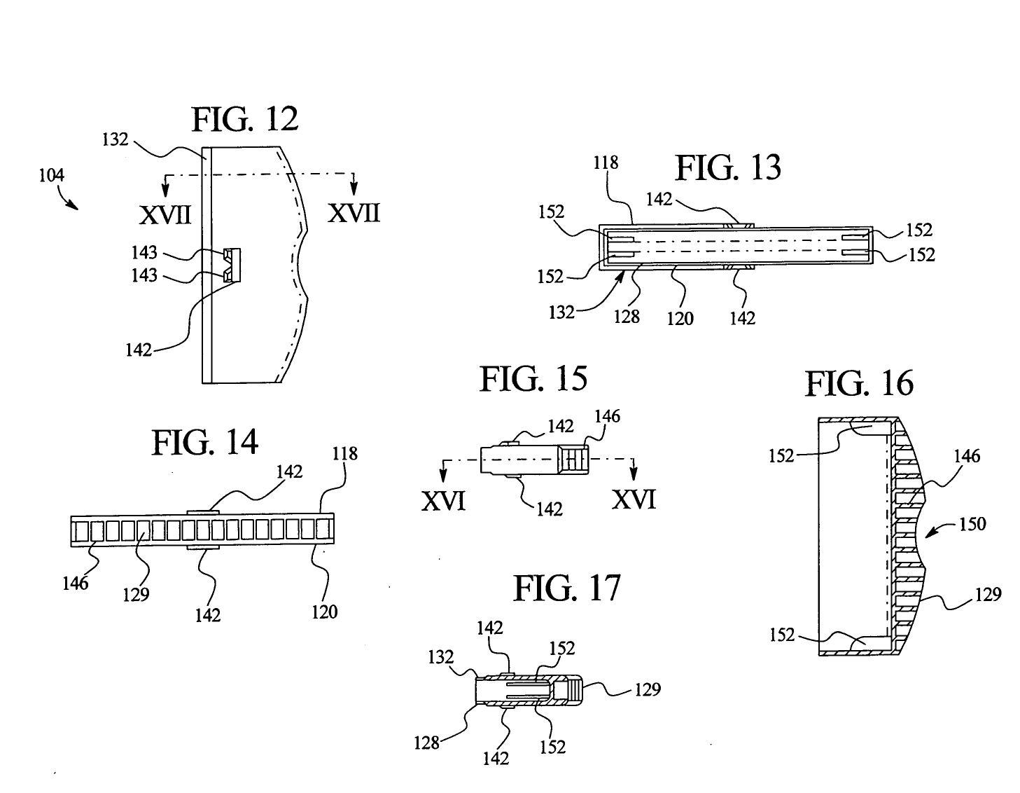

Referring now to FIGS. 8 to 19, another embodiment of the product dispenser is illustrated as dispenser 100. The products dispensed from dispenser 100 can be any of the products described above for use in connection with dispenser 100. Additionally, dispenser 100 may be made out of any suitable material such as those described above. Dispenser 100 includes a first housing 102 and a second 104. In one embodiment, housings 102 and 104 are smooth, transparent or translucent housings. Such materials enable the consumer to see or view how many individual products 16 remain within the dispenser 100. Alternatively, housings 102 and 104 can be tinted or colored while still enabling a consumer to view the products within the housing. Another embodiment, housings 102 and 104 are opaque. As described above, the material of housings 102 and 104 can be coated or treated to be resistant to ultraviolet light to help prevent the products contained within the housing from heating up, becoming tacky or melting. The inside surfaces of the housings 102 and 104 can also be coated to promote the dispensing of the products from the housings.

Housings 102 and 104 are held together by a member 106. The member 106 includes a bottom wall or bottom surface 108 and a top wall or top surface 110 which are separated by a divider 112. The member 106 also includes a first end 114 and a second end 116. It should be appreciated that the member 106 may be made of any suitable materials such as those listed above and in various preferred embodiments includes paper, foil, cardboard or any combination thereof. In an embodiment, member 106 and or housings 102 and or 104 include branding or designed indicia (not shown), which can be printed or attached directly to the member 106 and/or housings 102 and 104. Referring to FIG. 8, the first end 114 of member 106 includes a tamper resistant tab 107 that breaks or tears away when dispenser 100 is initially used by a user. A tamper resistant tab 107 can be made of any suitable material such as paper, cardboard or foil. The tab 107 may be made of the same or different materials from the member 106 and/or the housings 102 and 104.

In an embodiment, the tamper resistant tab 107 is connected or otherwise attached to the first end 114 of member 106 such that the tab breaks free when a user slides housing 102 over housing 104 within member 106. The tab 107 may be heat sealed on the front end of member 106 or adhered to the front end using a suitable adhesive. In an embodiment, the tab 107 is sized and constructed to attach to member 106 such as divider 112, the front end 126 of housing 102 and the front end 128 of housing 104. In another embodiment, separate tabs are attached to member 106 and housing 102 and member 106 and housing 104. Additionally, an additional tab or tabs 107 may be attached to the opposite ends of member 106, housing 102 and housing 104 to further prevent tampering or inadvertent opening of the dispenser 100. These tabs operate in a similar manner as tab 107 attached to dispenser 100.

Housings 102 and 104 are configured in a sliding relationship with member 106 to enable a user to dispense one or more products such as comestible products from the dispenser 100. In one embodiment, housings 102 and 104 are identical in size and shape and thereby minimize manufacturing costs by enabling the manufacturer to mass produce the interchangable housings 102 and 104. It should be appreciated that the housings may be any suitable size and shape. In the illustrated embodiment, housing 102 includes a top wall or surface 122 and a bottom wall or surface 124. A lip 130 is formed at one edge of the top wall 122 and the bottom wall or bottom 124 as seen in FIG. 8. The lip 130 enables the housing 102 to easily fit between the top wall 110 and the bottom wall 108 of member 106 for sliding engagement with member 106. Once engaged with member 106, lock member 144 is constructed to fit into opening or recess 134 formed in the top wall 110 of member 106. An identical opening or recess is formed in the same position on the opposite wall or bottom wall 108. Similarly, lock member 144 is positioned on the bottom wall 124 of the housing 102 to engage the opening on the bottom 108 of member 106. Each lock member 144 on housing 102 includes two arms 145. When lock member 144 is positioned in or engaged with opening 134 on member 106, the lock member 144 is sized to slide within the opening 134. As seen in FIG. 8, the opening 134 is sized to enable housing 102 to slide within member 106 a designated or predetermined distance. For example, lock member 144 may move from one end of opening 134 to the other end of opening 134 when housing 102 slides within member 106 to dispense one or more products. The lock member 144 slides within the opening 134 until the arms 145 engages one of the tabs 138 defined by the top wall 110 of member 106. The tabs 138 click or snap into or between the arms 145 of each lock member 144.

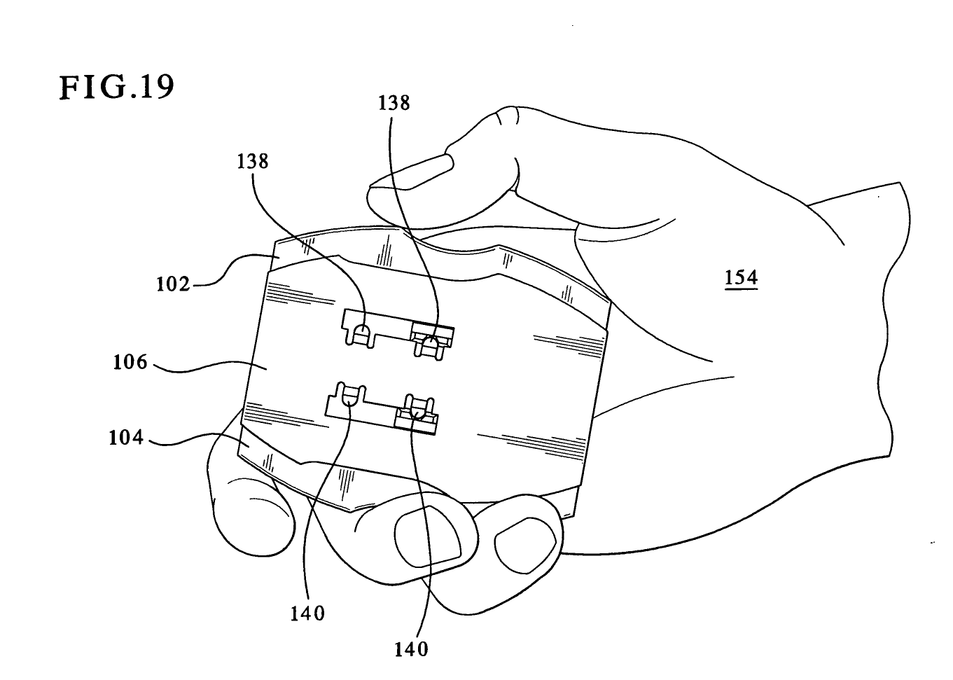

Accordingly, the engagement of tabs 138 between arms 145 sufficiently holds housing 102 in place within member 106. When the user desires to close or slide housing 102 back within member 106 to prevent further product from being dispensed from dispenser 100, the user slides housing 102 to its initial position (as shown in FIG. 19) which disengages arms 145 from tab 138. The openings 134 are positioned on member 106 to enable the arms 145 to engage tab 138 when housing 102 is in a closed position.

The engagement of tabs 138 and arms 145 thereby holds housing 102 within member 106 to prevent the housing 102 from accidentally or inadvertently sliding open and causing one or more pieces of the product to fall out of the product dispenser. Additionally, the positioning of lock member 144 in opening 134 prevents the housing 102 from inadvertently separating from member 106. If a user wants to remove housing 102 from member 106, the user pushes downward against the lock member 144 to disengage it from the opening 134 and the housing 102 can then be removed or pulled away from member 106. Accordingly, the housing 102 is removable and interchangeable to enable a user to refill the housing with product. Alternatively, the housing 102 can be thrown away after the product is completely dispensed from the housing and replaced with a new housing which is filled with product.

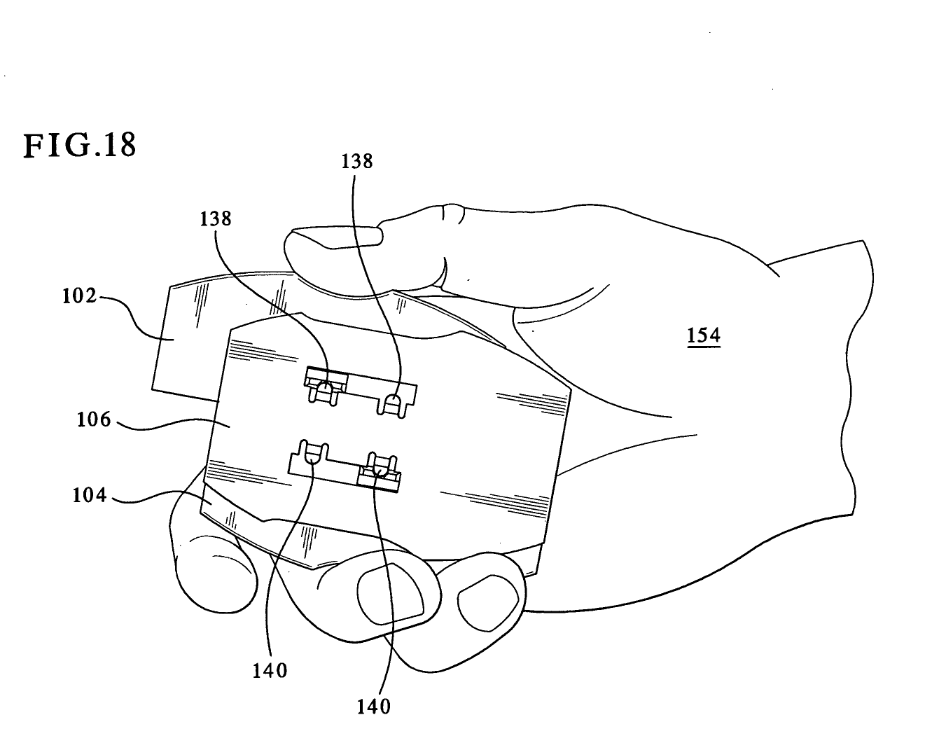

Similarly, housing 104 includes a front end 128 defining a lip 132 which enables housing 104 to fit within or between the top wall 110 and the bottom wall 108 of member 106. Housing 104 also includes product such as comestible product and slides within the member 106. Housing 104 includes a lock member 142 on the top wall or surface 118 and on the bottom wall or surface 120. The lock member 142 includes arms 143. The arms 143 engage one of the tabs 140 extending into opening 136 on the top wall 110 of member 106. The lock member 142 functions in a similar manner as the lock members 144 of housing 102. Accordingly, the user may slide housing 104 within member 106 similar to housing 102 to dispense one or more product from the dispenser 100. The tabs 140 act to engage arms 143 of lock member 142 to temporarily hold housing 104 in position when housing 104 is in either the open position or closed position as shown in FIGS. 18 and 19, respectively.

In the illustrated embodiment, housings 102 and 104 include a plurality of dividers 126 which form several compartments or receptacles in housings 102 and 104, respectively. The back or rear ends 127 and 129 of housings 102 and 104 also define a contour or indent 148 and 150. The indents 148 and 150 provide a location or position for a user's finger or fingers to enable the user to more easily slide housings 102 and 104 within member 106. Additionally, the dividers 146 provide different handling or gripping locations for the user's finger or fingers to enable the user to better hold or grasp the product dispenser to slide the housings within member 106.

The dispenser 100 therefore provides a desirable apparatus for users because the housings 102 and 104 may easily slide within member 106 to dispense one or more products from dispenser 100. Additionally, the lock members 142 and 144 of housings 102 and 104 enable users to temporarily lock or temporarily secure housings 102 and 104 in a particular position to dispense one or more products from the dispenser 100. The lock members 142 and 144 also enable the housings 102 and 104 to be temporarily secured in the closed position to prevent product from inadvertently falling out of or being removed from the dispenser 100. The dispenser 100 thereby provides a secure and easily operable apparatus which enables users to easily and efficiently dispense one or more products from the dispenser.

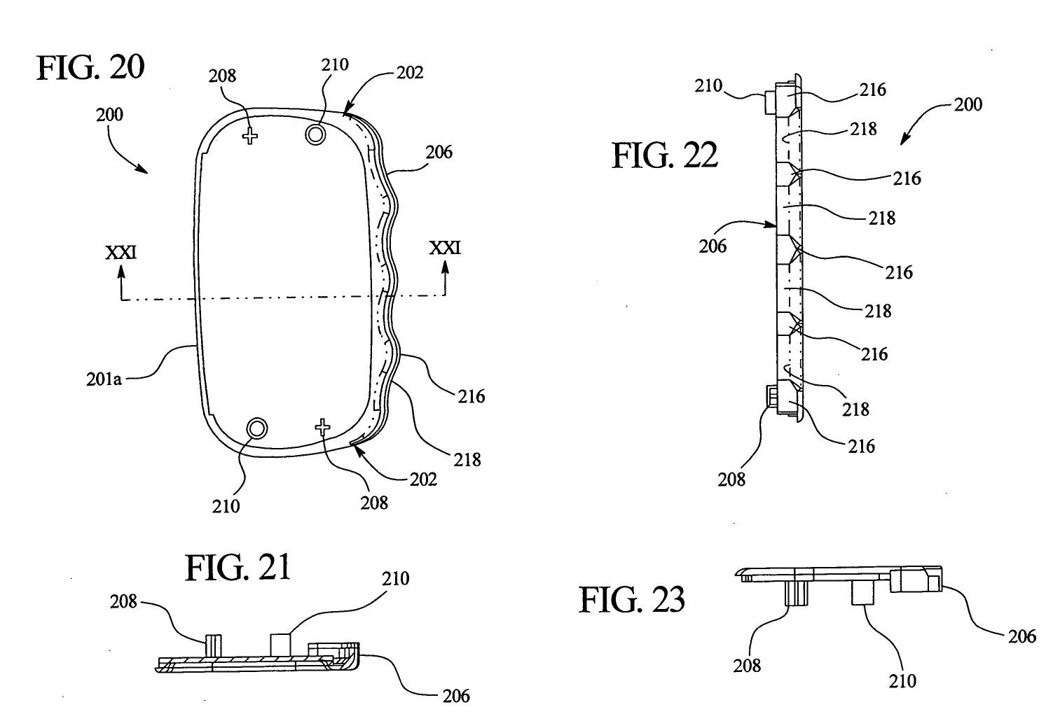

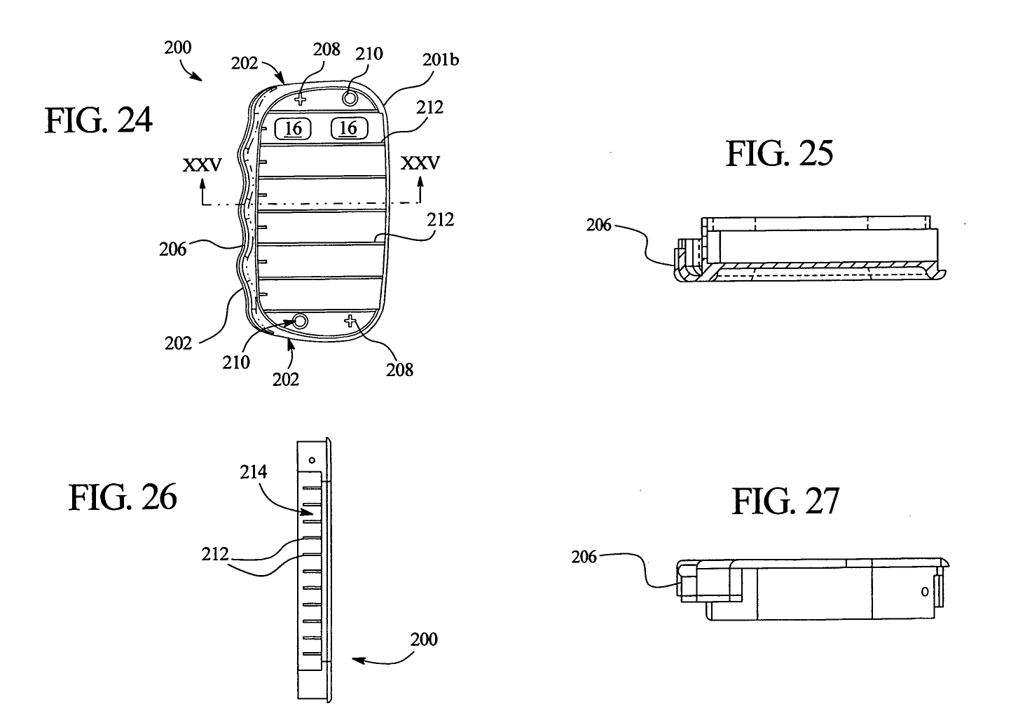

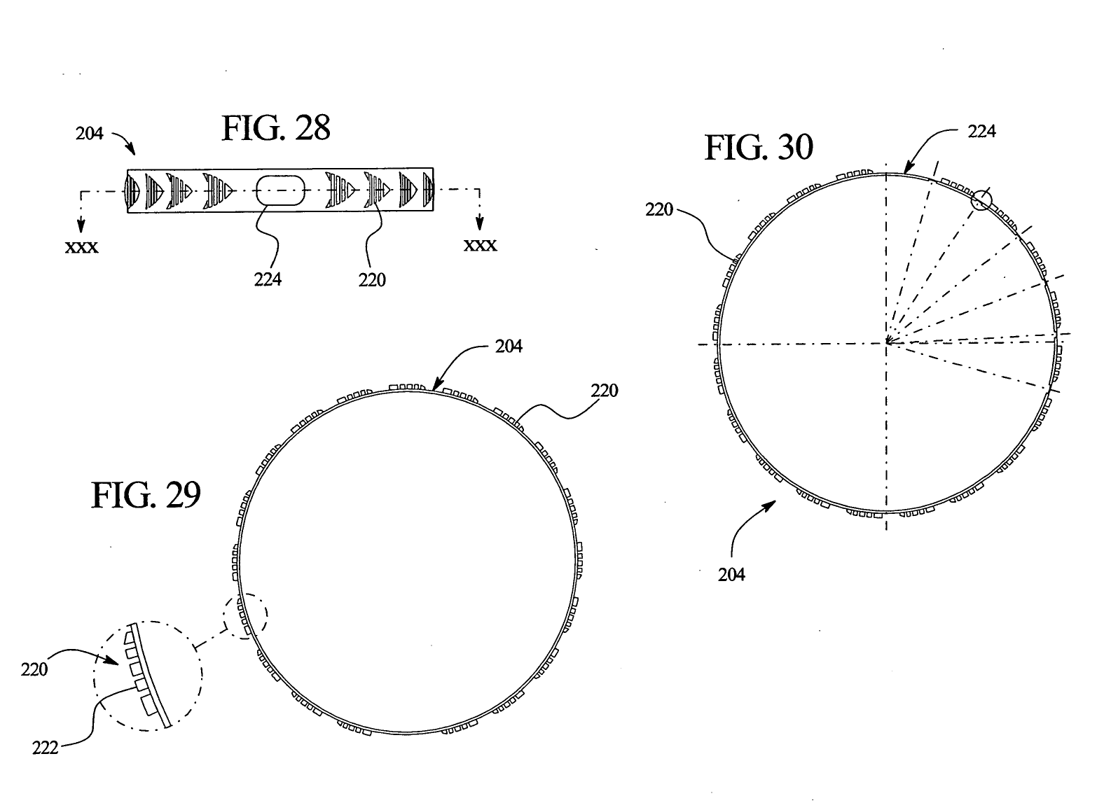

Referring now to FIGS. 20 to 30, another embodiment for dispensing products 16 is illustrated by dispenser 200. Any suitable product 16 can be dispensed from dispenser 200 as described above. Additionally, dispenser 200 and/or each of its various components can be manufactured using any suitable material as described above. Dispenser 200 includes similar components to the dispenser 50 described above and in addition includes a handle member or a grip 206. The handle member or grip 206 is configured to conform to a user's fingers to enable a user to hold the dispenser 200 while dispensing one or more products. The dispenser 200 generally includes a first housing 201a and a second housing 201b which are joined together by connecting male mount members 208 with corresponding female mount members 210 on housing 201a and 201b. The male mount members 208 and the female mount members 210 may be joined or attached together by snap fitting the members together or using any other suitable connection method. Each housing 201a and 201b define half of the grip 206 as seen in FIGS. 23 and 26. When housings 201a and 201b are combined together the halves of grip 206 are joined together to form the grip. In an embodiment, the grip 206 is contoured to enable a user to firmly hold the dispenser in one hand.

Specifically, the grip includes a plurality of protrusions 216 and recesses 218. The protrusions 216 and recesses 218 form the shape of the grip 206. The user's fingers are preferably placed in the recesses 218 in the grip. The protrusions 216 provide suitable resistance with the user's fingers to prevent the user's fingers from slipping off of the dispenser 200. It should be appreciated that the shape and size of the group 206 may be any suitable size and shape. It should also be appreciated that the protrusions and recesses may be any suitable shape or configuration.

A belt 204 similar to the belt described above for the dispenser 50 is positioned about the perimeter or peripheral surface of the joined housings 201a and 201b. In particular, the belt 204 is positioned about the housing such that the belt that is on the housings behind the grip 206 and extends beyond the grip through gaps 202 formed between the grip 206 and the main portion of the housings. The gaps 202 enable the belt 204 to be moved about the main portion of the housings to dispense one or more products as described above for dispenser 50.

In an embodiment, the belt 204 is made up of any suitable material as described above and includes one or more projections 220. In this embodiment, the projections are in the shape of arrows which preferably indicate that the direction of movement of the belt by the user. It should be appreciated that the projections 220 may be any suitable shape or configuration. The projections 220 include a plurality of tabs 222 which form a gripping surface for the user's finger or fingers. At tabs 222 therefore enable the dispenser to provide a tactile feel if movement of the belt above the main portion of the housings to dispense one or more products to the user. The belt 204 includes an opening 224 which is formed in the belt. Opening 224 is sized to correspond to the size of the product contained within the dispenser 200 and enables a user to dispense at least one product from the dispenser.

In operation, a user holds the dispenser 200 with one hand preferably by placing their fingers in the recesses of the grip 206. The user than uses their thumb to move the belt 204 about the main body of the dispenser by pushing against one or more of the projections 220. The force of the user's finger against the projection 220 causes the belt to move in the direction of force applied to the belt. When the opening 224 is aligned with one of the compartments 214 separated by dividers 212, the product 16 contained within the compartment is dispensed from the dispenser 200. User may then move or rotate the belt 204 about the main body of the dispenser 200 to dispense one or more additional products 16 from the dispenser. It should be appreciated that the belt 204 may be moved in either direction to dispense products from the dispenser. To prevent any remaining product from dispensed from the dispenser, the user moves the belt 204 to either end of the dispenser, which do not include compartments 214 or in a position adjacent to a compartment 214 where the product in that compartment has previously been dispensed. The dispenser 200 thereby enables a user to hold or grip the dispenser in one hand while dispensing comestible product from the dispenser. The product can therefore be easily and quickly dispensed from the dispenser with minimal effort by a user.

It should be understood that various changes and modifications to the presently preferred embodiments described herein will be apparent to those skilled in the art. Such changes and modifications can be made without departing from the spirit and scope of the present disclosure and without diminishing its intended advantages. It is therefore intended that such changes and modifications be covered by the appended claims.

1. A comestible product dispenser comprising:
a first housing sized to hold a plurality of comestible products;
a second housing sized to hold a plurality of the comestible products;
a member adapted to hold the first and second housings, the member including a top wall and a bottom wall, the top wall and the bottom wall defining a first side and a second side, the first side receiving in a sliding relationship the first housing and the second side receiving in a sliding relationship the second housing;
a first stop located on one of the top wall and the bottom wall of the member; and
a second stop located on one of the top wall and the bottom wall of the member, wherein the first and second stops are so constructed and arranged to temporarily secure the first and second housings in an open position or a closed position when the first and second housings are translated sequentially along the member to dispense one of the products.

2. The comestible product dispenser of claim 1, wherein the first housing and the second housing are constrained initially by a tamper resistant tab.

3. The comestible product dispenser of claim 1, wherein the first housing and the second housing are constrained initially by a plurality of tamper resistant tabs.

4. A comestible product dispenser comprising:
a housing sized to hold a plurality of the comestible products, the housing including a top wall and a bottom wall separated by a plurality of dividers;
a dispensing member surrounding the housing and positioned between the top wall and the bottom wall, the dispensing member defining at least one opening and being movable along the dividers; and
a holding member connected to the housing, the holding member configured to enable a user to hold the housing in one hand while enabling the user to selectively move the dispensing member with the same hand to position the opening between the dividers to dispense one of the products.

5. The comestible product dispenser of claim 4, wherein the holding member includes a contoured surface.

6. The comestible product dispenser of claim 4, wherein the opening is covered initially by a tamper resistant tab.

7. A method of dispensing comestible product comprising the steps of:
providing a plurality of comestible products in a first housing and a second housing, wherein the first housing and the second housing are each in a sliding arrangement with a member having a first stop and a second stop;
selecting at least one of the first housing and the second housing to slide along the member from a closed position to an open position;
sliding the selected housing along the member to the open position when the selected housing engages one of the first stop and the second stop;
dispensing the comestible product from the selected housing;
sliding the selected housing along the member to the closed position.

8. The method of claim 7, wherein the first housing includes a first tab and the second housing includes a second tab, said first and second tabs being so constructed and arranged to engage the first and second stops to limit the movement of the first and second housings along the member.

9. A method of dispensing comestible product comprising the steps of:
providing a housing including comestible product, the housing defining an opening and including a holding member;
holding the housing in a first hand;
positioning at least one finger of the first hand on a belt surrounding the housing, the belt defining an opening; and
rotating the belt around the housing using at least the one finger to align the openings and selectively enable products to be dispensed through the aligned openings of the housing and the belt.

10. The method of claim 9, which includes providing tactile devices so that the opening of the belt can be set at a desired position until being moved again.
